(19) United States
(12) Patent Application Publication
(10) Pub. No.: US 2024/0275192 A1
(43) Pub. Date: Aug. 15, 2024

(54) PHONE CHARGE PORT ADAPTOR

(71) Applicant: MEMS DRIVE (NANJING) CO., LTD., NANJING (CN)

(72) Inventors: Annie Qu, Arcadia, CA (US); Andrew Qu, Arcadia, CA (US)

(21) Appl. No.: 18/110,171

(22) Filed: Feb. 15, 2023

(51) Int. Cl. H02J 7/00

(52) U.S. Cl. CPC H02J 7/0045; H02J 7/00047

(57) ABSTRACT

The present disclosure is directed towards a multiple port phone charger. In this product, which we can switch from Type A to type C and do any combination switch among Type A male, Type Mini B female, Type C female, Type C male, Type Micro B male, and lightning male. The ports are not limited to just listed ports. The integrated PCB inside the package has different layout to achieve multiple functions.

### CROSS-REFERENCE TO RELATED APPLICATIONS

This application is a new application.

### FIELD OF THE INVENTION

The present disclosure relates generally to phone charge port adaptor. More particularly, the adaptor can switch among USB type A, Type C, Micro B, Mini B and Lightning ports.

### BACKGROUND

An adaptor to convert USB type C port into lightning port or convert lightning port to type C port is easily found, but it is difficult to find one, which can covert from mini B or micro B.

In some products, we can find the cables with three type charge ports, which is not convenient and took up space and difficult to carry, or some products, which can switch different charge ports. For example, a brand Nestelle produced a product, which can charge micro-B, type C. and lightning port, but they have to put the new port head on and off, and will be difficult to store and affect life time.

### BRIEF SUMMARY OF EMBODIMENTS

The present disclosure is directed towards a multiple port phone charger. In this product, which we can switch from Type A to type C and do any combination switch among Type A male, Type Mini B female, Type C female, Type C male, Type Micro B male, and lightning male.

In some embodiments, the arrangements of different ports are shown. The ports can be arranged at a different way and the product shape can vary like an apple, start or any other shapes.

Some embodiments disclosed herein provide a method of assembling the components together and how to integrate them together.

Other features and aspects of the disclosure will become apparent from the following detailed description, taken in conjunction with the accompanying drawings, which illustrate, by way of example, the features in accordance with embodiments of the disclosure. The summary is not intended to limit the scope of the invention, which is defined solely by the claims attached hereto.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments of the disclosure. These drawings are provided to facilitate the reader's understanding of the disclosure and shall not be considered limiting of the breadth, scope, or applicability of the disclosure.

FIG. 1 is a 3D illustration of a multiple head adapter.

FIG. 2 is an exploded 3D illustration of a multiple head adapter.

FIG. 3 is an illustration of bottom and top cover.

FIG. 4 is an illustration of a base and placed separated connectors.

FIG. 5 is an illustration of base and integrated connectors.

FIG. 6 is an illustration of the top cover view.

These figures are not intended to be exhaustive or to limit the invention to the precise form disclosed. It should be understood that the embodiments of the disclosure can be practiced with modification and alteration and can be limited only by the claims and the equivalents thereof.

### DETAILED DESCRIPTION OF THE EMBODIMENTS

The present disclosure is directed towards a multiple charger adapter.

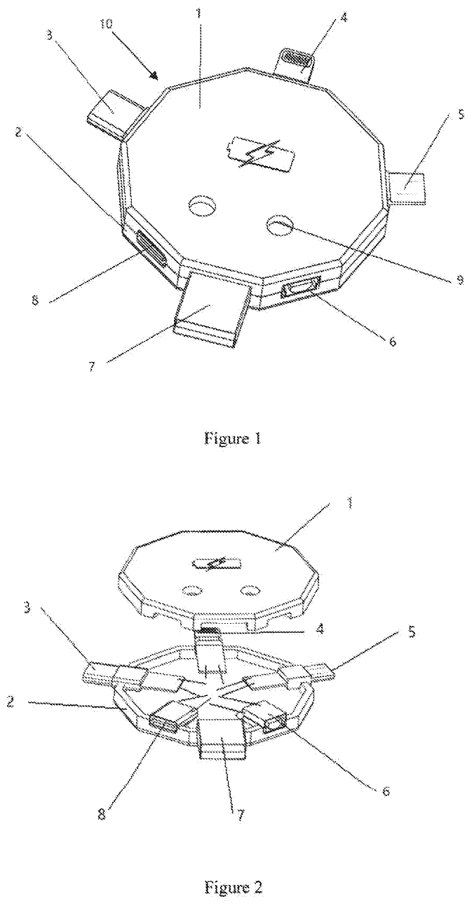

FIG. 1 is a 3D illustration of a multiple head adapter. The adapter 10 includes top cover 1 and bottom base 2 and different charge ports Type C 3, lightning 4. Micro type B 5, Mini type B female 6, Type A 7, and Type C female 8. The product shape is not necessary to be decagon, and it can be any shape like apple and star as long as the ports can easily to access.

FIG. 2 is an exploded 3D illustration of a multiple head adapter. The base 2 has 6 openings, which allow the ports 3, 4, 5, 6, 7 and 8 are arranged respectively. In this picture, separated ports with separated PCBs 3, 4, 5, 6, 7, and 8 are arranged, and the ground and V pins of each port will be connected to the ground and V by soldering or wirebonding. An integrated pcb can be used to save the assembly time.

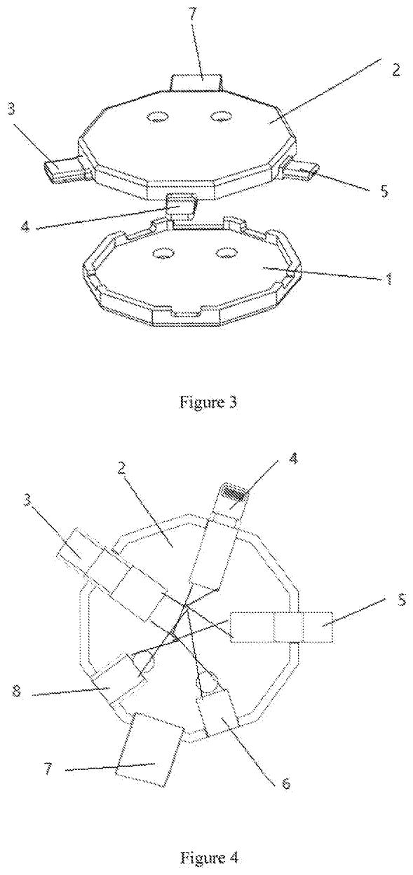

FIG. 3 is an illustration of bottom and top cover. It illustrated the exploded upside-down view.

FIG. 4 is an illustration of a base and placed separated connectors. In this picture, we detailed how the separated ports with separated PCBs 3, 4, 5, 6, 7, and 8 are arranged on bottom cover 2, and the ground and V pins of each port will be connected to the ground and V by soldering or wirebonding. An integrated pcb can be used to save the assembly time.

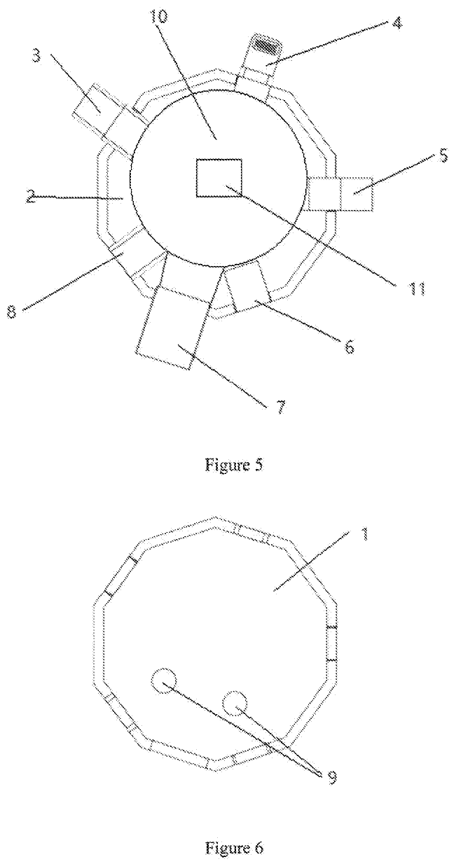

FIG. 5 is an illustration of base and integrated connectors. In this illustration, charge ports 3, 4, 5, 6, 7 and 8's connections are integrated by one PCB, so the wire bonding steps are reduced. The integrated PCB 10 is shown and a switch bottom II can be added based on the need.

FIG. 6 is an illustration of the top cover view. There are holes 9 on the top cover 1 and base 2. A chain or wire can go through the holes, so later it can be hooked on the backpack or key chains.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in various embodiments. Such embodiments are not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although this disclosure describes various example embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments, whether or not such embodiments are described and whether or not such features are presented as being a part of a described embodiment. Thus, the breadth and scope of the present disclosure should not be limited by any of the above-described example embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide example instances of the item in discussion, not an exhaustive or limiting list thereof; the terms “a” or “an” should be read as meaning “at least one,” “one or more” or the like; and adjectives such as “conventional,” “traditional.” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other component, can be combined in a single package or separately maintained and can further be distributed in multiple groupings or packages or across multiple locations.

Additionally, the various embodiments set forth herein are described in terms of example block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A package of multiple port adapter comprising:
A base with multiple openings process, which allow different charge ports to access, a top cover with logo and holes, a USB type A male, USB type C male and female, USB micro-B male, Mini B female, and lightning male.

2. The package of claim 1, further comprising, separated PCB with wire bonding for grounds and V.

3. The package of claim 1, further comprising integrated PCB, which connect all the ports together.

4. The method of claim 3, further comprising a switch bottom can be added to have better control of the adapter.

5. The method of claim 1, further comprising:
The top and bottom cover are fabricated with holes, which can used to hanging a wires or chains to hook to the backpack or anything portable components.

6. The method of claim 1, further comprising:
The top and bottom cover can be different shapes.

7. The method of claim 1, further comprising:
The different ports can be arranged differently and are not limited to only listed ports.

8. The method of claim 3, further comprising:
The PCB layout can connect Ground, V and data pins to achieve more functions.
